(19) United States
(12) Patent Application Publication
(10) Pub. No.: US 2012/0155876 A1
(43) Pub. Date: Jun. 21, 2012

(54) SEED LIGHT MODULE FOR WAVELENGTH DIVISION MULTIPLEXING-PASSIVE OPTICAL NETWORK AND METHOD FOR DRIVING THE SAME

(75) Inventors: Seung-Hyun Cho, Daejeon-si (KR); Han-Hyub Lee, Daejeon-si (KR); Jie-Hyun Lee, Daejeon-si (KR); Jong-Hoon Lee, Daejeon-si (KR); Eun-Gu Lee, Daejeon-si (KR); Eui-Suk Jung, Daejeon-si (KR); Sang-Soo Lee, Daejeon-si (KR)

(73) Assignee: ELECTRONICS AND TELECOMMUNICATIONS RESEARCH INSTITUTE, Daejeon-si (KR)

(21) Appl. No.: 13/333,119

(22) Filed: Dec. 21, 2011

(30) Foreign Application Priority Data
Dec. 21, 2010 (KR) 10-2010-0131744

(51) Int. Cl. H04J 14/02; H04J 14/06

(52) U.S. Cl. 398/65; 398/79

(57) ABSTRACT

A seed light module for a WDM-PON system is provided. The seed light module includes a reflector configured to reflect a part of seed light that is generated from a light source generator, and an optical attenuator configured to attenuate the intensity of the reflected seed light and provide the attenuated seed light, which corresponds to a signal generated by attenuating the intensity of the reflected seed light, to the light source generator.

### CROSS-REFERENCE TO RELATED APPLICATION

This application claims the benefit under 35 U.S.C. §119(a) of Korean Patent Application No. 10-2010-0131744, filed on Dec. 21, 2010, the disclosure of which is incorporated by reference in its entirety for all purposes.

### BACKGROUND

1. Field

The following description relates to a seed light module for a wavelength division multiplexing-passive optical network.

2. Description of the Related Art

A wavelength division multiplexing-passive optical network (WDM-PON) uses a reflective type semiconductor optical amplifier as a light source unit for a central office or optical network terminal. The reflective type semiconductor optical amplifier having colorless characteristics provides a solution for solving stock management problem with spare optical transceivers and has attracted much attention in recent years. Such a WDM-PON with a reflective modulator needs to have an additional seed light to select a predetermined wavelength for up and downstream transmission.

In general, two types of methods have been being employed to implement a seed light. According to the first example of a seed light, an incoherent light with a broad bandwidth, which is generated from a high power erbium doped optical fiber amplifier or a high power semiconductor optical amplifier, is spectrally sliced into a Continuous Waves (CW) light source having a narrow bandwidth by using a wavelength demultiplexer to obtain light source suitable for a wavelength-division-multiplexing-based transmission system. According to the second method of implementing a seed light, an array of single longitudinal mode operated light sources is used.

The first example provides the cost effectiveness, wavelength independency and reduces optical power penalty caused by a back-reflection induced noise in a single fiber bi-directional transmission that is essential when configuring a passive optical network. However, relative intensity noise due to the spectrum slicing is increased, the power of seed light is reduced by the narrow bandwidth of a filter used in the spectrum slicing and it is not easy to achieve a long haul transmission due to a dispersion penalty that is caused a relatively larger optical spectral bandwidth.

Meanwhile, according to the second method, an individual light source needs to be provided for each wavelength consisting of seed light, and optical power penalty due to back-reflection induced noise is deteriorated. However, a long haul transmission is possible due to a narrow line width, a relative intensity noise characteristic is superior to the first method and optical power output from individual light sources is enough to operate an optical transmitter for uplink/downlink signal generation with a small amount of optical power loss. In this regard, many studies have been undertaken to develop an array type seed light with multiple single-mode-operated laser sources.

### SUMMARY

In one aspect, there is provided a seed light module for a wavelength division multiplexing-passive optical network (WDM-PON) system, the seed light module including: a reflector configured to reflect a part of seed light that is generated from a light source generator; and an optical attenuator configured to intentionally attenuate the intensity of the reflected seed light and provide the attenuated seed light to the light source generator.

The optical attenuator may change the intensity of a seed light, which is generated from the light source generator, and produces an attenuated signal to the reflector.

The seed light module may further include a polarization controller configured to control a polarization state of a seed light, which is generated from the light source generator, and provides the seed light, which has controlled polarization state, to the reflector.

The seed light module further include a polarization controller configured to match a polarization state of the attenuated seed light, which is input from the optical attenuator, to a typical polarization state of a seed light generated from the light source generator and transmit the attenuated seed light, which has been aligned to the typical polarization state, to the light source generator.

The seed light module may further include a wavelength multiplexer/de-multiplexer configured to perform multiplexing on the seed light, which is generated from the light source generator, or de-multiplexing on the seed light, which is received from the optical attenuator.

The seed light module may further include an optical coupler configured to split the seed light generated from the light source generator to an optical line terminal (OLT) and the optical attenuator, or transmit the seed light, which is received from the optical attenuator, to the light source generator.

The light source generator may include array type laser diodes configured to provide a multiple single longitudinal-mode-operated light.

In another general aspect, there is provided a method for driving a seed light module for a wavelength division multiplexing-passive optical network (WDM-PON) system, the method including: at a light source generator, generating a seed light; at a reflector, reflecting apart of generated seed light; at an optical attenuator, attenuating intensity of the reflected seed light; and providing an attenuated seed light to the light source generator.

The method may further include at the optical attenuator, attenuating the generated seed light.

The method may further include at a polarization controller, controlling a polarization state of the seed light.

The method may further include at the polarization controller, matching a polarization state of the attenuated seed light to a polarization state of the originally generated seed light, and producing the seed light, which has been aligned to the typical polarization state, to the light source generator.

The method may further include at a wavelength multiplexer/de-multiplexer, performing multiplexing on the generated seed light; and at the multiplexer/de-multiplexer, performing demultiplexing on the attenuated seed light.

The method may further include at an optical coupler, splitting the generated seed light to an optical line terminal (OLT) and the optical attenuator.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of a wavelength division multiplexing-passive optical network (WDM-PON) system.

FIG. 2 is a diagram illustrating an example of a seed light module.

FIG. 3 is a diagram illustrating another example of a seed light module.

FIG. 4 is a flowchart illustrating an example of the control flow of a method for driving a seed light module of a WDM-PON system.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings.

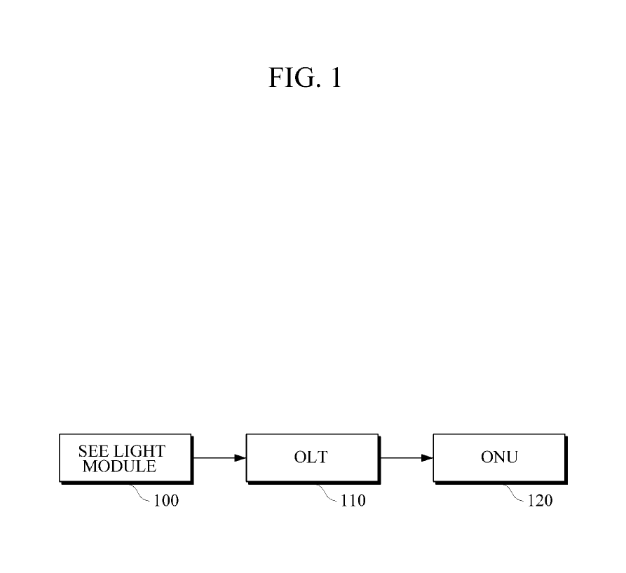

FIG. 1 is diagram illustrating an example of a wavelength division multiplexing-passive optical network (WDM-PON) system.

A wavelength division multiplexing-passing optical network (WDW-PON) system includes a seed light module 100, an optical line terminal (OLT) 110 and an optical network unit (ONU) 120.

The seed light (SL) module 100 is configured to generate a seed light. The SL module 100 outputs the generated seed light to the OLT 110.

The OLT 110 generates a downstream signal using seed light and transmits the generated downstream signal to the ONU, etc.

The OLT 110 serves as equipment forming a passive optical network, and represents an end point installed at a service provider's network side. For example, the OLT 110 may be served as a multiservice platform to connect a passive optical network to core or metro network, and include a SIPP device, a cable television, a transport device and a network management device, etc. The OLT 110 can be located between a user and a service node.

The ONU 120 represents end point equipment that is installed at a subscriber's premise to make an access to an optical network. The ONU 120 establishes a connection to a passive optical network using a user interface.

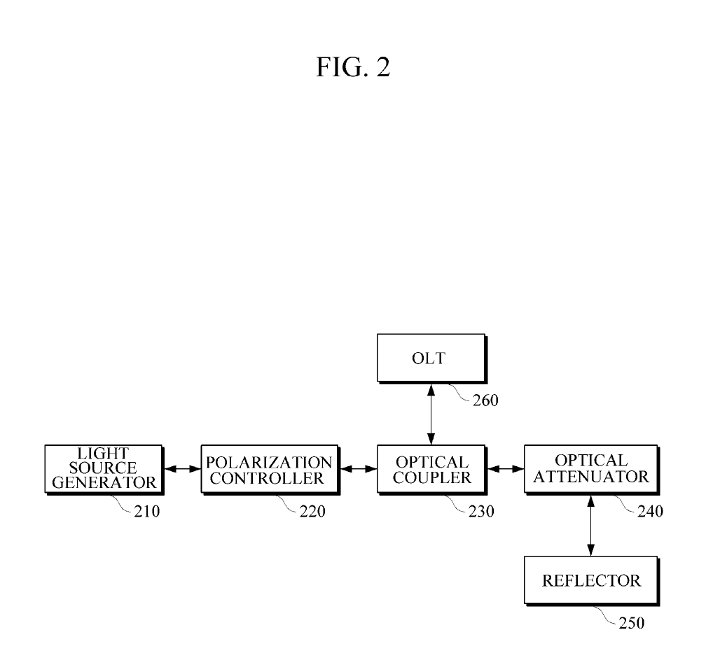

FIG. 2 is a diagram illustrating an example of a seed light module.

Referring to FIG. 2, a seed light module includes a light source generator 210, a polarization controller 220, an optical coupler 230, an optical attenuator 240 and a reflector 250.

The light source generator 210 generates a seed light (SL). For example, the light source generator 210 may generate continuous waves having different wavelengths.

The light source generator 210 may be implemented based on a single longitudinal-module-operated laser source. The light source generator 210 may be provided with individual laser sources to be suitable for WDM transmission system. For example, the individual light sources may be implemented using a laser diode, such as a DFB-LD (Distributed-Feedback Laser Diode), an ECL (external cavity laser) or DBR-LD (distributed Bragg reflector based laser diode), that makes a single longitudinal mode operation with electrical current input. Each of light sources provides a bundle of light having narrow bandwidths that are suitable for a long reach transmission.

The polarization controller 220 is configured to control the polarization state of the seed light that is provided by the light source generator 210. The polarization controller 220 provides a seed light, which has been aligned to arbitral polarization state, to the optical coupler 230.

The polarization controller 220 matches the polarization state of a first seed light, which is generated from the light source generator 210, and the polarization state of a second seed light, which is reflected back after passing through the optical coupler 230. Thereafter, the polarization controller 220 provides the second seed light, which has been aligned to a typical polarization state, to the light source generator 210. The second seed light emitted from the polarization controller 220 contributes to interference, so that a seed light generated from the light source generator 210 produces a relatively larger optical spectral bandwidth.

The optical coupler 230 splits a seed light, which is generated from the light source generator 210, to the optical attenuator 240 and the optical line terminal 260.

The optical coupler 230 receives the seed light, which has been reflected from the reflector 250 and then passed through the optical attenuator 240, and produces the received seed light to the polarization controller 220. If the polarization controller 220 is missing, the optical coupler 230 receives the seed light, which has been reflected from the reflector 250 and then passed through the optical attenuator 240, and produces the received seed light to the light source generator 210.

The optical attenuator 240 may attenuate the intensity of a seed light that is output from the optical coupler 230 toward the reflector 250. The optical attenuator 240 adjusts the intensity of the seed light introduced to the reflector 250.

The optical attenuator 240 may attenuate the intensity of a seed light that is reflected form the reflector 250. The optical attenuator 240 may adjust the intensity of a seed light, which is to be injected into the polarization controller 220 through the optical coupler 230. That is, the optical attenuator 240 adjusts the intensity of a seed light that is introduced to the reflector 250 or a seed light that is reflected from the reflector 250, thereby adjusting the intensity of the seed light that is to be reinjected into the light source generator 210.

The reflector 250 reflects a part of seed light that is input to the reflector 250. For example, the reflector 250 reflects a part of seed light, which has been output from the optical coupler 230, such that the seed light is reintroduced to the optical coupler 230. For example, the reflector 240 may be formed on a ferrule cross section of an optical fiber patch code. The reflector 250 is formed by externally being coated with metal material that can reflect light.

This example of the seed light module can increase the optical spectral bandwidth of the seed light by performing polarization control through the polarization controller and adjusting the optical intensity through the optical attenuator. Accordingly, a long haul transmission can be achieved in WDM-PON, and optical power penalty caused by the back-reflection induced noise can be reduced.

In addition, this example of the seed light module can broaden the optical spectral bandwidth of seed light without adding expensive electrical and optical components. That is, the seed light module employs reflection components of the seed light, which is generated from the existing seed light generator, thereby broadening the optical spectral bandwidth. Accordingly, the seed light module has a simple structure.

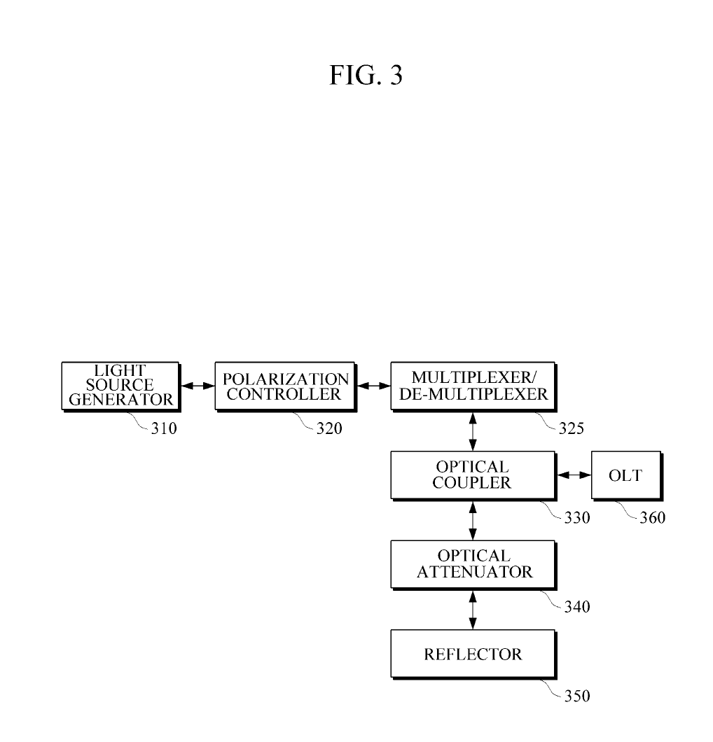

FIG. 3 is a diagram illustrating another example of a seed light module.

As shown in FIG. 3, a seed light module includes a light source generator 310, a polarization controller 320, a wavelength multiplexer/de-multiplexer 325, an optical coupler 330, an optical attenuator 340 and a reflector 350.

The light source generator 310 generates a seed light (SL). For example, the light source generator 310 may generate continuous waves having different wavelengths. For example, in order to generate a plurality of seed lights, the light source generator 310 may be implemented using a plurality of laser diodes that generate seed light each having a different single wavelength.

The polarization controller 320 is configured to control the polarization state of a seed light generated from the light source generator 310. The polarization controller 320 provides the seed light, which has been aligned to polarization state, to the multiplexer/de-multiplexer 325.

The polarization controller 320 matches the polarization state of a seed light, which is generated from the light source generator 310, and the polarization state of a seed light, which is partially reflected by the reflector 350. Thereafter, the polarization controller 320 provides the polarization aligned seed light, which has been subject to the typical polarization state, to the light source generator 310. Interference occurs due to the seed light introduced from the polarization controller 320, so that a seed light generated from the light source generator 310 has an increased optical spectral bandwidth.

The multiplexer/de-multiplexer 325 may perform a wavelength division multiplexing on the seed light, which is output from the polarization controller 320. The multiplexer/de-multiplexer 325 may provide the multiplexed seed light to the optical coupler 330. If the polarization controller 320 is missing, the multiplexer/de-multiplexer 325 may perform a wavelength division multiplexing on the seed light, which is directly multiplexed from the light source generator 310.

The multiplexer/de-multiplexer 325 may perform a de-multiplexing on the seed light that is output from the optical coupler 330. The multiplexer/de-multiplexer 325 provides the demultiplexed seed light to the polarization controller 320. If the polarization controller 320 is missing, the multiplexer/de-multiplexer 325 may output the de-multiplexed seed light directly to the light source generator 310.

The optical coupler 330 divides the seed lights, which are generated from the light source generator 310, to the optical attenuator 340 and the optical line terminal 360.

The optical coupler 330 may provide a seed light, which has been received from the optical attenuator 340, to the multiplexer/de-multiplexer 325.

The optical attenuator 340 attenuates the intensity of the seed light that is output from the optical coupler 330. The optical attenuator 340 may change the power level of seed light to the reflector 350. The optical attenuator 340 may adjust the intensity of the seed light that is to be injected into the reflector 350.

The optical attenuator 340 may attenuate the intensity of the seed light that is reflected form the reflector 350. The optical attenuator 340 may change the power level of seed light to the optical coupler 330. The optical attenuator 340 may adjust the intensity of the seed light, which is input light to the polarization controller 320 through the optical coupler 330.

The optical attenuator 340 adjusts the intensity of the seed light that is output from the optical coupler 330 and/or the intensity of the seed light that is output from the reflector 350.

The reflector 350 reflects the seed light that is input to the reflector 350. For example, the reflector 350 reflects a part of the seed light, which is output from the optical attenuator 240, to the optical coupler 330.

According to this example of the seed light module, even when a plurality of channels are provided, a broad optical spectral bandwidth of the seed light can be generated by performing polarization control and optical reflection. Accordingly, a long reach transmission can be achieved in WDM-PON and an optical power penalty caused by the back reflection induced noise can be reduced.

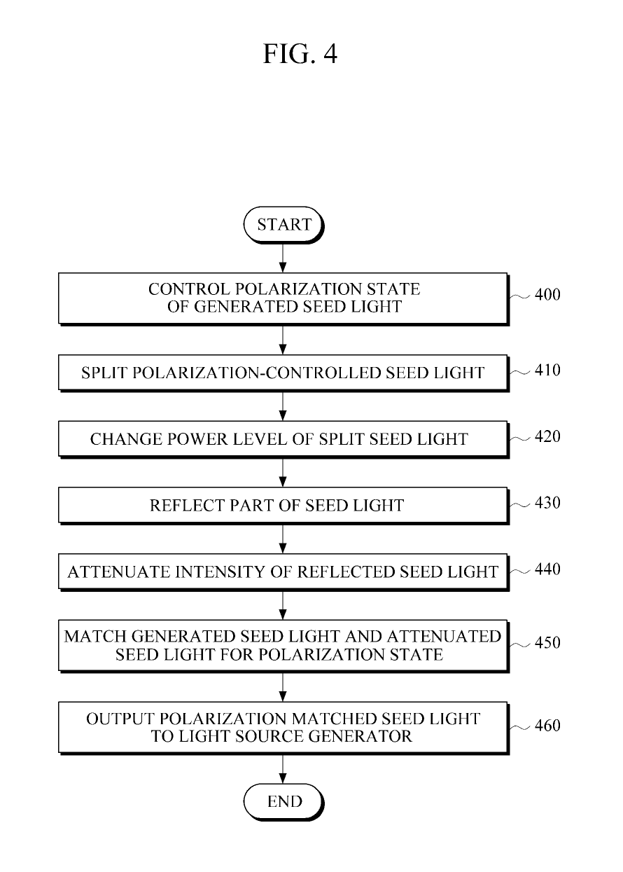

FIG. 4 is a flowchart illustrating an example of the control flow for driving a seed light module of a WDM-PON system.

As shown in FIGS. 2 and 4, as an example, the light source generator generates a seed light. The polarization controller controls the polarization state of the seed light generated in the light source generator (400). The optical coupler splits the polarization-controlled seed light (410). The polarization controlled seed light is injected into the OLT and the optical attenuator. The optical attenuator changes the power level of each spilt seed light (420). The reflector reflects a part of seed light which is power-controlled through the optical attenuator (430). The optical attenuator attenuates the intensity of the seed light that is reflected by the reflector (440). The intensity attenuated seed light passes through the optical coupler and then transmitted to the polarization controller. That is, the seed light which has been reflected by the reflector can be re-injected into the polarization controller. The polarization controller matches the polarization state of the seed light, which is generated from the light source generator, to the polarization state of the reflected seed light, (450). The polarization controller outputs the polarization-controlled seed light to the light source generator (460). The seed light that is input from the polarization controller contributes to interference, so that a seed light generated from the light source generator has an increased optical spectral bandwidth.

As another example where a plurality of beams of seed light are also generated from a light source generator, the multiplexer/de-multiplexer may multiplex the seed lights that are generated from the light source generator. In addition, the multiplexer/de-multiplexer may de-multiplex a seed light.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A seed light module for a wavelength division multiplexing-passive optical network (WDM-PON) system, the seed light module comprising:
a reflector configured to reflect a part of seed light that is generated from a light source generator; and
an optical attenuator configured to intentionally attenuate the intensity of the reflected seed light and provide the attenuated seed light to the light source generator.

2. The seed light module of claim 1, wherein the optical attenuator changes the intensity of a seed light, which is generated from the light source generator, and produces an attenuated signal to the reflector.

3. The seed light module of claim 1, further comprising a polarization controller configured to control a polarization state of a seed light, which is generated from the light source generator, and provides the seed light, which has controlled polarization state, to the reflector.

4. The seed light module of claim 1, further comprising a polarization controller configured to match a polarization state of the attenuated seed light, which is input from the optical attenuator, to a typical polarization state of a seed light generated from the light source generator and transmit the attenuated seed light, which has been aligned to the typical polarization state, to the light source generator.

5. The seed light module of claim 1, further comprising a multiplexer/de-multiplexer configured to perform multiplexing on the seed light, which is generated from the light source generator, or de-multiplexing on the seed light, which is received from the optical attenuator.

6. The seed light module of claim 1, further comprising an optical coupler configured to split the seed light generated from the optical generator to an optical line terminal (OLT) and the optical attenuator, or transmit the seed light, which is received from the optical attenuator, to the light source generator.

7. The seed light module of claim 1, wherein the light source generator comprises a laser diode configured to output a single longitudinal-mode-operated light.

8. A method for driving a seed light module for a wavelength division multiplexing-passive optical network (WDM-PON) system, the method comprising:
at a light source generator, generating a seed light;
is at a reflector, reflecting the generated seed light;
at an optical attenuator, attenuating intensity of the reflected seed light; and
providing an attenuated seed light to the light source generator.

9. The method of claim 8, further comprising:
at the optical attenuator, attenuating the generated seed light.

10. The method of claim 8, further comprising, at a polarization controller, controlling a polarization state of the seed light.

11. The method of claim 8, further comprising:
at the polarization controller, matching a polarization state of the attenuated seed light to a typical polarization state of the generated seed light; and
providing the seed light, which has been aligned to the typical polarization state, to the light source generator.

12. The method of claim 8, further comprising:
at a multiplexer/de-multiplexer, performing multiplexing on the generated seed light; and
at the multiplexer/de-multiplexer, performing demultiplexing on the attenuated seed light.

13. The method of claim 8, further comprising
at an optical coupler, splitting the generated seed light to an optical line terminal (OLT) and the optical attenuator.
